(19) United States
(12) Patent Application Publication
(10) Pub. No.: US 2008/0230715 A1
(43) Pub. Date: Sep. 25, 2008

(54) Optical Imaging

(75) Inventors: Tim Nielsen, Hamburg (DE); Udo Van Stevendaal, Ahrensburg (DE); Bernhard Gleich, Hamburg (DE); Tobias Schaeffter, Blackheath (GB); Paul Haaker, Hamburg (DE); Peter Mazurkewitz, Hamburg (DE); Steffen Weiss, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/997,417

(22) PCT Filed: Jul. 25, 2006
(86) PCT No.: PCT/IB2006/052543

§ 371 Date: Jan. 31, 2008

(30) Foreign Application Priority Data
Aug. 1, 2005 (EP) 05107099.3

(51) Int. Cl. G01J 1/58

(52) U.S. Cl. 250/458.1

(57) ABSTRACT

An optical imaging apparatus (100) for examination of an object of interest (101), the optical imaging apparatus (100) comprising an optical radiation source (102) adapted to emit a primary optical radiation beam onto the object of interest (101), an optical radiation detector (106) adapted to detect a secondary optical radiation beam emitted by the object of interest (101) upon absorbing the primary optical radiation beam, a magnetic field generating element (107) adapted to generate an inhomogeneous magnetic field varying along an extension of the object of interest (101), and a determination unit (108) adapted to determine information concerning the object of interest (101) based on an analysis of the detected secondary optical radiation beam in combination with an analysis of the inhomogeneous magnetic field.

The invention relates to the field of optical imaging. In particular, the invention relates to an optical imaging apparatus and method, to a probe, to a use of the probe, to a computer-readable medium, and to a program element.

Fluorescence imaging in turbid media (for instance tissue) may suffer from the fact that the spatial resolution may be relatively poor due to strong scattering of the excitation light and the emitted fluorescence light as well.

It is an object of the invention to enable optical imaging with a proper resolution.

In order to achieve the object defined above, an optical imaging apparatus, a probe, a use of the probe, an optical imaging method, a computer-readable medium and a program element with the features according to the independent claims are provided.

According to an exemplary embodiment of the invention, an optical imaging apparatus for examination of an object of interest is provided, the optical imaging apparatus comprising an optical radiation source (or a plurality of optical radiation sources) adapted to emit a primary optical radiation beam onto the object of interest, an optical radiation detector (or a plurality of optical radiation detectors) adapted to detect a secondary optical radiation beam emitted by the object of interest upon absorbing the primary optical radiation beam, a magnetic field generating element adapted to generate an inhomogeneous magnetic field varying along an extension of the object of interest, and a determination unit adapted to determine information concerning the object of interest based on an analysis of the detected secondary optical radiation beam in combination with an analysis of the inhomogeneous magnetic field.

According to another exemplary embodiment of the invention, a probe attachable to an object of interest under examination is provided, the probe comprising a donor adapted to absorb a primary optical radiation, and an acceptor adapted to emit a secondary optical radiation upon absorption of the primary optical radiation by the donor, wherein the donor and the acceptor are adapted in such a manner that at least one property of the secondary optical radiation depends on a magnetic field strength at the position of the probe.

Furthermore, according to an exemplary embodiment of the invention, the probe having the above mentioned features is used for examining the object of interest with an optical imaging method applying an inhomogeneous magnetic field varying along an extension of the object of interest.

According to another exemplary embodiment of the invention, an optical imaging method of examining an object of interest is provided, the method comprising the steps of generating an inhomogeneous magnetic field varying along an extension of the object of interest, emitting a primary optical radiation beam onto the object of interest, detecting a secondary optical radiation beam emitted by the object of interest upon absorbing the primary optical radiation beam, and determining information concerning the object of interest based on an analysis of the detected secondary optical radiation beam in combination with an analysis of the inhomogeneous magnetic field.

According to still another exemplary embodiment of the invention, a computer-readable medium is provided, in which a computer program of examining an object of interest is stored, which computer program, when being executed by a processor, is adapted to control or carry out the above mentioned steps.

According to yet another exemplary embodiment of the invention, a program element of examining an object of interest is provided, which program element, when being executed by a processor, is adapted to control or carry out the above mentioned method steps.

The imaging of an object of interest according to the invention can be realized by a computer program, i.e. by software, by using one or more special electronic optimization circuits, i.e. in hardware, or in hybrid form, i.e. by means of software components and hardware components.

The characterizing features according to the invention particularly have the advantage that an optical imaging system is provided which may allow imaging also in turbid media like tissue, since a novel kind of probe and a novel kind of method for optical imaging, particularly optical fluorescence imaging, are provided which may allow for high resolution by means of a modulating magnetic field. According to one aspect of the invention, the fluorescence of the probe irradiated with optical light is modulated by an externally applied magnetic field.

A probe molecule according to an exemplary embodiment of the invention may contain a donor and an acceptor entity with the following properties: if the donor is optically excited, an electron is transferred to the acceptor resulting in a charge transfer complex in a singlet state. This complex can cross over to a triplet state with a rate depending on the strength and/or the direction of an external magnetic field. Both states, the triplet and the singlet state, may have separate decay channels by which the excitation energy is transferred to the environment. For instance, the singlet state can predominantly emit fluorescence radiation, and the triplet state can predominantly emit phosphorescence radiation.

“Phosphorescence” may be distinguished from “fluorescence” by its spectrum and/or lifetime. Both phosphorescence and fluorescence can be considered to be electromagnetic radiation produced by certain substances after absorbing radiant energy or other types of energy.

Provided that the singlet state primarily emits fluorescence, and the triplet state primarily emits phosphorescence, by recording the fluorescence and phosphorescence contributions, the population of the singlet and triplet states can be measured. Since the inter-system crossing rate may depend on a magnetic field, the fluorescence/phosphorescence signal may also depend on the magnetic field. This effect is used according to the invention to emit the distribution of the probe by using an inhomogeneous magnetic field which provides some kind of spatial resolution.

However, compared to magnetic resonance imaging (MRI), the required strength of the magnetic field employed according to the invention is very low. A field on the order of the earth magnetic field may be sufficient to saturate the influence of the magnetic field on the inter-system crossing rate. Consequently, the required gradients to achieve high spatial resolution are generated easily.

A shielding means for shielding the earth magnetic field is possible but may not be absolutely necessary as a measure against disturbing effects. It may be even more important to provide a shielding means to suppress time-varying disturbing magnetic fields. More generally speaking, a compensation of external disturbing magnetic fields may be advantageous.

According to an exemplary embodiment of the invention, a magnetic shielding element or compensation element is provided which may be arranged around the optical imaging apparatus in order to reduce or eliminate the influence of the earth magnetic field or other disturbing magnetic fields, particularly of time-varying magnetic fields. This may significantly improve the sensitivity and accuracy of the system.

Optionally, additional molecules (for instance anti-bodies) can be bound to the probe that target the probe to biomolecular structures of interest which may thus be investigated according to the invention.

Molecules having the properties described above, that is to say having a singlet state and a triplet state which population and transitions properties depend on an applied magnetic field, and having an acceptor and a donor, are known as such (see Grampp, G. et al. (2002), “Electron self-exchange kinetics in the systems pyrene/dicyanobenzene isomers determined by MARY spectroscopy”, RIKEN Review, No. 44, pp. 82 to 84; Ritz, T. et al. (2000), “A Model for Photoreceptor-Based Magnetoreception in Birds”, Biophysical Journal, Vol. 78, pp. 707 to 718). For instance, pyrene-dicyanobenzene exciplexes or Ru(II)-trisbipyridine are examples for such molecular systems. It is believed that the magnetoreception of some birds is likely based on the above effect.

Molecular imaging with high sensitivity (comparable to PET, “Positron Emission Tomography”, and better) may be achieved. However, radioactive probes are dispensable according to the invention. A high spatial resolution may be obtained for optical fluorescence imaging/tracking.

Exemplary fields of application of the invention are molecular imaging, optical imaging of tissue, and optical tracking in turbid media.

Since photons at optical wavelengths are not harmful to biological tissue, as are for instance X-ray photons, the system according to the invention are appropriate for medical applications, since the optical imaging modalities according to the invention do not destroy tissue of a human being. Thus, a magnetic field modulated optical probe and imaging method may be provided.

Thus, according to an aspect of the invention, substance detection by optical excitation is enabled, wherein the common problem that the spatial information is difficult to detect due to strong scattering of the optical radiation at the object of interest may be overcome by selecting a position of an object of interest by applying an inhomogeneous magnetic field to the object of interest. For instance, a gradient field may be applied to the object of interest in such a manner that, at one particular position of the object of interest, the magnetic field strength is essentially zero, and the magnetic field is different from zero at all other positions. Then, due to the magnetic field sensitive fluorescence/phosphorescence marker, the fluorescence/phosphorescence properties of the point with a vanishing magnetic field differs from the fluorescence/phosphorescence properties of all other parts of the object of interest at which the magnetic field is different from zero. In other words, a field free point may be investigated, and the position of this field free point may be scanned or sampled (for instance by moving the object of interest or by moving the magnetic field distribution), so that the field free point can be changed along the extension direction of the object of interest.

It is possible to excite the object of interest or a probe attached to the object of interest in a continuous manner, that is to say by applying a continuous electromagnetic beam. Alternatively, it is possible to excite the sample in a pulsed manner, and to measure the time dependence of the fluorescence/phosphorescence signal. Since phosphorescence radiation has significantly longer time constants (e.g. microseconds to seconds) compared to typical fluorescence time constants (e.g. picoseconds to nanoseconds), the contribution of fluorescence and phosphorescence may be distinguished by an analysis in the time domain. In the case of a continuous excitation beam, an energy or frequency analysis of the fluorescence/phosphorescence radiation is possible, since the wavelengths of those two different radiation contributions may differ significantly. It may also be possible to simply measure a reduction or an increase of fluorescence or phosphorescence due to a modulation of the magnetic field.

According to one aspect of the invention, absorption of excitation light may populate an excited singlet state, wherein the system relaxes to the ground state by a transition from the excited singlet state to the ground state under emission of a photon which can be detected. Such a photon may be fluorescence radiation. In the absence of an external magnetic field, a transition from the excited singlet state to an excited triplet state which may, however, be located energetically below the excited singlet state, may be forbidden, so that a direct transition from the excited singlet state to the ground state may be dominant.

In the presence of a magnetic field, a transition rate from the excited singlet state to the excited triplet state may be increased in correlation with the strength and/or direction of the magnetic field, so that the triplet state may be populated by a transition from the excited singlet state. Then, under emission of a photon, the system may relax from the excited triplet state to the ground state, wherein energy and/or time constants of this transition may differ from energy and/or time constants of the transition from the excited singlet state to the ground state. This may allow to distinguish both decay channels.

Thus, when a magnetic field is switched on, the photon intensity related to the transition from the excited singlet to the ground state may be weakened, and the contribution resulting from a transition from the excited triplet state to the ground state may become stronger. This may allow to assign radiation to a particular position at an object of interest, provided that the field distribution at the position of the object of interest is known or measured.

One exemplary field of application of the invention is tumour detection. When a tumour is assumed to be present in a particular organ of a body of a human being, a sample containing tumour-antibodies to which a donor and an acceptor with magnetic field sensitive properties is attached may be provided in an environment of this organ. In case that a tumour is present in this organ, the antibody acting as some kind of linker molecule binds to the tumour, and thus the donor and acceptor molecules accumulate in the vicinity of the tumour. By irradiating this tumour with optical radiation which may be absorbed by the donor-acceptor pair, by modulating the magnetic field in the region of this tumour and by measuring the characteristics of the fluorescence and/or phosphorescence radiation, the tumour may be detected indirectly by detecting the probes attached thereto.

There are several opportunities for arranging magnetic field generating devices to generate the magnetic field distribution at the position of the object of interest. One possibility is to arrange a plurality of conductors as Maxwell coils, that is to say in a manner so that a field free point is generated in the middle between the conductors, surrounded by a magnetic field distribution.

Alternatively, a specially shaped permanent magnet may be used to provide a magnetic field distribution. This permanent magnet may then be guided along the object of interest so that the field distribution generated by the permanent magnet is present at the position of the object of interest.

It is also possible to provide an arrangement of a plurality of conductors, particularly coils, which may be put on the object of interest without the necessity to surround the object of interest with the coils or permanent magnets. This may allow a simple operation of the system, for instance in the frame of a medical application.

According to one aspect of the invention, the optical properties of an object of interest or of a contrast medium injected into an object under examination should depend on the magnetic field. Examples for optical properties are quantum yield, absorption and/or emission spectrum, lifetime (also spectrally resolved).

As an object under examination, any system can be used which has magnetic field dependent optical properties. Examples for a suitable system are charger transfer complexes, singlet-triplet transition systems, chemiluminescence systems, etc. Further, the system does not necessarily comprise two separate entities (donor and acceptor). It is also possible that the entire process takes place within one molecule, so that different molecule states fulfil the function of a donor and of an acceptor.

According to one aspect of the invention, a time-resolved measurement is performed. In such a time-resolved measurement, one or more pulsed lasers may be used. However, it is also possible to estimate the lifetime of fluorescence and phosphorescence by means of a modulation method. In the context of such a modulation method, the exciting optical radiation may be, with high-frequency, amplitude modulated. The modulation and the phase of the emission may be measured (so-called “frequency domain lifetime measurement”).

According to an exemplary embodiment of the invention, a method for analyzing a measured spectrum is provided which may be based on the technology of “diffuse optical tomography” (DOT). In this context, explicit references is made to Gibson, A P, Hebden, J C, Arridge, S R (2005), “Recent advances in diffuse optical imaging”, Phys. Med. Biol. 50 (2005) R1-R43. In said reference, the technology of diffuse optical imaging is reviewed, which may involve generating images using measurements of visible or near-infrared light scattered across large thicknesses of tissue. In the context of near-infrared optical imaging, explicit references is further made to Hawrysz, D J, Sevick-Muraca, E M (2000), “Developments Toward Diagnostic Breast Cancer Imaging Using Near-Infrared Optical Measurements and Fluorescent Contrast Agent”, Neoplasia, Vol. 2, No. 5, September-October 2000, pages 388-417.

In the context of a diffuse optical tomography (DOT) system according to an exemplary embodiment of the invention, strongly scattering media may be investigated with light in the range of wavelengths between 400 nm and 1200 nm, more particularly between 600 nm and 1000 nm. However, these ranges may be extended to higher and lower wavelengths. For instance, tomographic measurements may be performed, that is to say the light may be injected at different positions (for instance by means of optical fibers or by direct irradiation) of an object under investigation, and the light which is re-emitted by the object may be detected. This can be performed in the frame of a pure intensity measurement, but also in the frame of a time-resolved (directly or in the frequency domain) or spectrally-resolved measurement. One or a plurality of wavelengths can be used for irradiation of the object. In addition to the intrinsic optical properties of the tissue investigated, absorbing or fluorescent contrast media may optionally be introduced in the object. From the measured data, one or more images of the object or a part thereof may be reconstructed subsequently.

According to exemplary embodiments of the invention, the diffused optical tomography technology may be significantly improved particularly concerning the following two aspects:

Firstly, the resolution of the analysis may be improved. Without systematically applying magnetic fields, the resolution (in dependence of the dimension of the object) may be relatively poor, like approximately 10 mm (for instance with an object diameter of 10 cm). With a systematically applied magnetic field, the achievable resolution may be significantly improved and may depend on the magnitude of the gradient of the magnetic field and may depend on characteristics of the contrast agent or the object. A resolution of 1 mm and less may be possible.

Secondly, the handling of the so-called “inverse problem” may be improved. When reconstruction an image from the measurement data, the so-called “inverse problem” has to be solved, that is to say to estimate coefficient functions from solutions of the diffusion equation. This problem may be numerically difficult to solve. This is a significant fundamental problem for image reconstruction in general. The reason for this is the diffuse spreading of light: the sensitivity volume for a given irradiation and detection position is very large, that is to say the portion of the object which influences the measurement. Abstractly formulated, this is a strongly smooth forward operator. When applying a magnetic field, the size of the sensitivity volume can be determined, adjusted and restricted by the characteristics of the magnetic field. Particularly, small volumes which are restricted in all three spatial directions may be selectively investigated, so that the above-mentioned problems may be solved or reduced. In other words, the magnetic field configuration can be used to improve the solvability of the inverse problem.

Consequently, an improved signal-to-noise ratio may be achieved.

The propagation of light in tissue can, in many cases be described properly by means of the so-called diffusion approximation. For a small object or for special cases, for instance when transparent liquids are present (head, brain liquid), there are other methods which the person skilled in the art knows from the state of the art.

−∇·D∇Φ+μₐΦ=q₀ (1)

In equation (1), Φ denotes the local photon density, and μₐ and D denote the absorption and the scatter coefficient of the tissue, respectively. q₀ denotes the source distribution. Equation (1) describes only the propagation of the irradiated light in the continuous case (for time-resolved measurements, equation (1) may be extended by considering additional terms). When fluorescence and/or phosphorescence is/are additionally present, further terms should be added describing the propagation of the corresponding radiation:

−∇·D_{f}∇Ψ+μ_{a,f}Ψ=εcγΦ (2)

As source term on the right hand side of equation (2), the corresponding generation process can be written (in the above example linear fluorescence excitation, wherein ε is the molar extinction coefficient, c is the concentration and γ is the quantum yield of the fluorescence dye).

Implementing N detector and M source configurations (wavelength and spatial distribution), the measurement Φ_{i,j} are obtained with i=1, . . . , N, j=1, . . . , M, respectively, additionally ψ_{i,j}. For a DOT analysis, the problem has to be solved to estimate the coefficient functions μₐ, D, c from the measurement values.

However, alternatives are possible:

Instead of directly reconstructing the coefficients, a model for the coefficients can be used and the model parameters may be reconstructed. This may be reasonable after having measured with a plurality of wavelengths, and when the absorption can be attributed to known substances.

$${μ}_{a} ( λ ) = {\sum }_{s} {ɛ}_{s} ( λ ) {c}_{s} \qquad ( 3 )$$

In this case, the concentrations cₛ may be reconstructed.

Using additionally a magnetic field, there is an additional degree of freedom (index) which describes the magnetic field configuration: Φ=Φ_{i,j,k}.

It is assumed that A is a forward model which depends on parameters p and can be predict the light intensity Φ.

A(p)=Φ (4)

The inverse problem can, in generally, be described as follows: determine the parameter p in such a manner that the deviation between the measured values y and the calculated values become minimum. In many cases, for stabilization, an additional condition may be formulated for p (regularization). That is to say, when reconstructing, p is determined in such a manner that the following equation becomes minimum:

∥A(p)−y∥²+R(p) (5)

For R, it is possible to use R=λ∥p∥².

In the following, further exemplary embodiments of the system according to the invention will be described.

Next, exemplary embodiments of the optical imaging apparatus will be described. However, these embodiments also apply for the probe, the use of the probe, the optical imaging method, the computer-readable medium and the program element.

The magnetic field generating device of the optical imaging apparatus may be realized as at least one conductor to which an electrical current is applicable. A conductor or an arrangement of a plurality of conductors allows to generate a magnetic field distribution which is precisely controllable or measurable. For instance, a field distribution may be generated which essentially has a magnetic field only at a particular position and a vanishing electromagnetic field apart from this position. Assuming a probe system having a singlet and a triplet, the latter being only populated in the presence of a magnetic field, this particular point at which the magnetic field differs from zero can be sensitively resolved by the corresponding phosphorescence radiation.

Additionally or alternatively, the magnetic field generating element may be realized as one or a plurality of permanent magnets. By the shape or the geometrical distribution of one or more permanent magnets, it is also possible to exactly define a magnetic field distribution and to sample an object of interest for instance by moving the object of interest, by moving the magnetic field generating element or by operating the magnetic field generating element in a manner that the spatial distribution of the magnetic field is changed (for instance changing a current distribution in a conductor).

The optical radiation detector may be a spatially resolving detector. By combining the magnetic field modulation with the spatial resolution of a detector (for instance a CCD array), the sensitivity and accuracy of the detection according to the invention may be improved.

Additionally or alternatively, the optical radiation detector may be a frequency or energy resolving detector. By taking this measure, it may be possible to distinguish between different radiation components, for instance a high-frequency transition related to a singlet-ground state transition, and a lower-frequency contribution related to a triplet-ground state contribution.

Additionally or alternatively, the optical radiation detector may be a time resolving detector. Particular in combination with a pulsed emission of the primary optical radiation beam, it is possible to distinguish between contributions based on different half-life periods of different transition channels.

Particularly, the optical radiation detector may be capable of distinguishing between a fluorescence component and a phosphorescence component in the secondary optical radiation beam. Such a separation of different components may be based on different frequencies, different half-life periods, different spatial contributions, or the like.

Furthermore, the determination unit may be adapted to determine information concerning the object of interest based on an analysis of a fluorescence component and/or a phosphorescence component in the secondary optical radiation beam. For instance, the determination unit may detect only the fluorescence component, since a phosphorescence component can be filtered out. When the fluorescence component becomes weaker, this may be a hint that a phosphorescence component is present. Alternatively, the determination unit may analyze both, fluorescence component and phosphorescence component and determine a position from which the radiation stems, by an analysis of the ratio between fluorescence and phosphorescence components.

The determination unit of the optical imaging apparatus may further be adapted to determine information concerning the object of interest based on an analysis of a ratio between the fluorescence component and the phosphorescence component in the secondary optical radiation beam.

The determination unit may be adapted to determine structural information concerning the object of interest based on an analysis of the detected secondary optical radiation beam in combination with an analysis of the inhomogeneous magnetic field. In other words, the information may be information concerning the spatial distribution of the object of interest. Thus, 2D or 3D structural information may be obtainable.

The determination unit may further be adapted to determine information concerning a selectable portion of the object of interest at which portion the magnetic field strength has a predetermined value. The predetermined value of the magnetic field strength may be zero. That is, the object of interest may be scanned by the varying magnetic field, and the portion of the object of interest which, at a point of time, perceives no magnetic field, has emission properties (e.g. triplet transmission forbidden, therefore no phosphorescence) that differ from the emission properties of other portions of the object of interest which perceive a magnetic field. This may allow to spatially resolve a particular portion of the object of interest.

The magnetic field generating element may be adapted to modulate the magnetic field along an extension of the object of interest.

In the following, exemplary embodiments of the probe will be described. However, these embodiments also apply for the optical imaging apparatus, the use of a probe, the optical imaging method, the computer-readable medium or the program element.

The probe may comprise a linker molecule coupled to the donor and to the acceptor and adapted to be attachable to the object of interest. Such a linker molecule may, for instance, be an antibody which selectively couples to a corresponding molecule, for instance a tumour. Then, the linker molecule may adhere to any tumour cells present in the environment. By taking this measure, and by measuring fluorescence and phosphorescence radiation emitted by the donor-acceptor pair in response to the absorption of exciting optical radiation, the presence of tumour cells can be detected with high accuracy.

The aspects defined above and further aspects of the invention are apparent from the examples of embodiment to be described hereinafter and are explained with reference to the examples of embodiment.

The invention will be described in more detail hereinafter with reference to examples of embodiment but to which the invention is not limited.

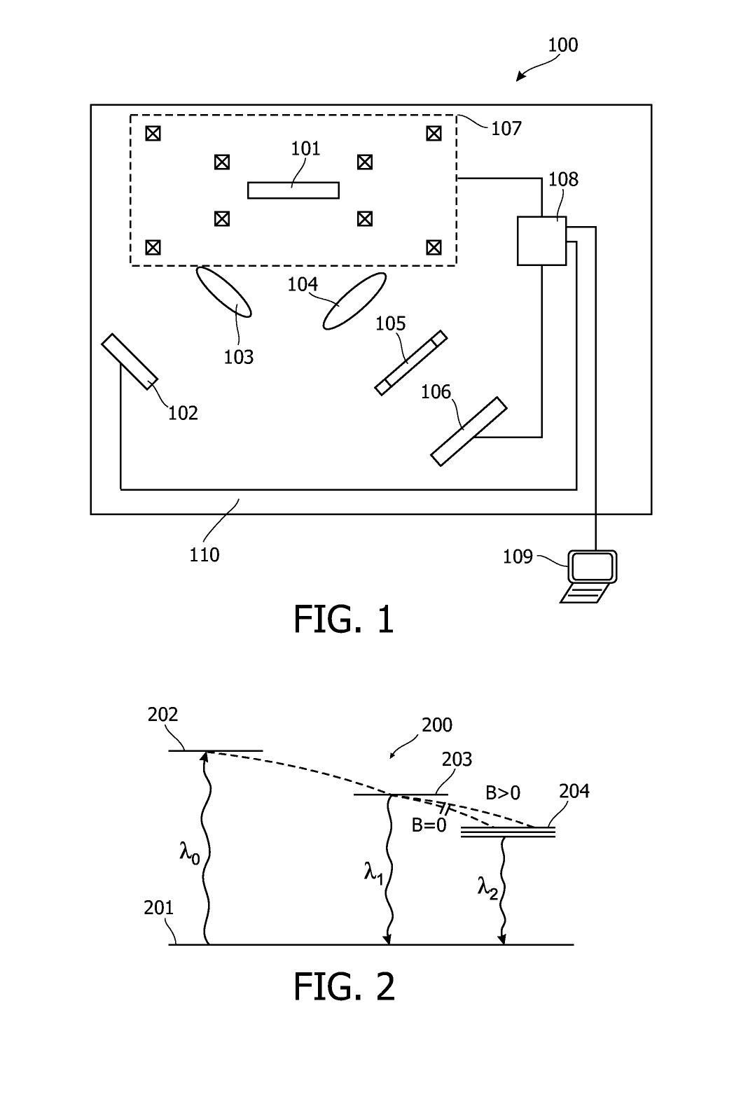

FIG. 1 shows a schematic view of an optical imaging apparatus according to an exemplary embodiment of the invention.

FIG. 2 shows an energy level diagram illustrating processes involved in creating an excited electronic singlet state and an excited electronic triplet state by optical absorption and processes involved in subsequent emission of fluorescence and phosphorescence in the presence of an external magnetic field.

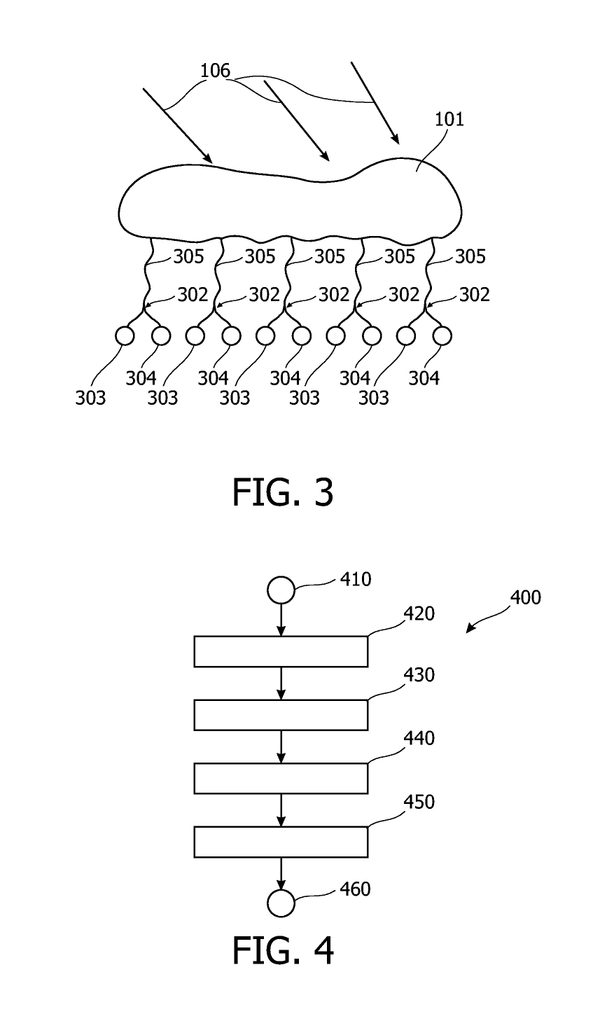

FIG. 3 shows an object of interest and a probe according to an exemplary embodiment of the invention attached to the object of interest.

FIG. 4 shows a flow chart of an optical imaging method according to an exemplary embodiment of the invention.

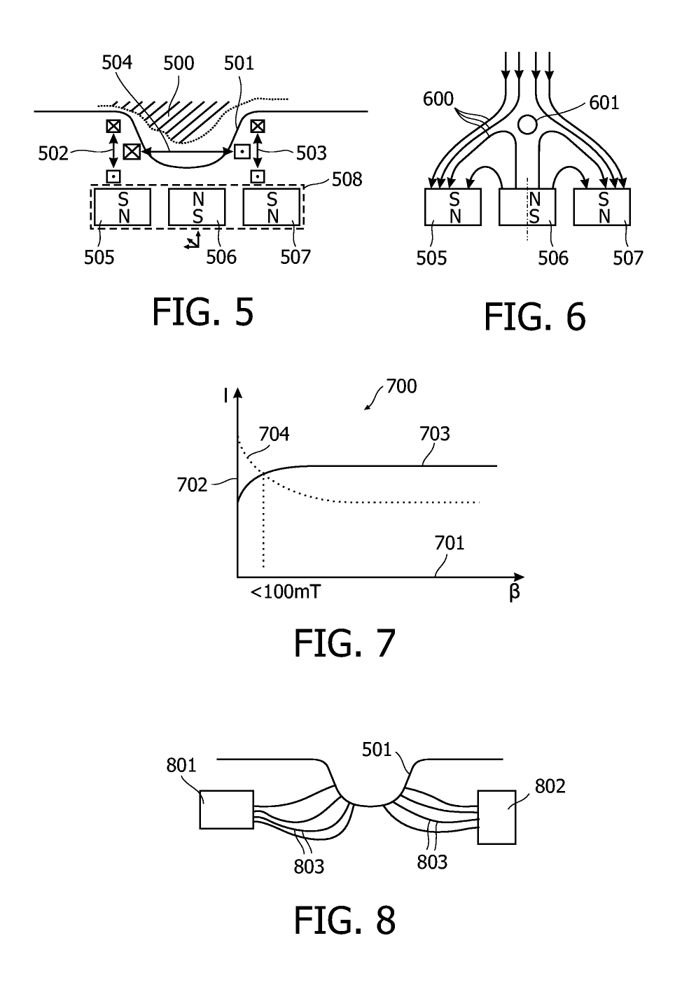

FIG. 5 shows a configuration of magnetic field sources of an optical imaging apparatus according to an exemplary embodiment of the invention.

FIG. 6 shows a schematic view of a magnetic field distribution generated by magnetic field sources of FIG. 5.

FIG. 7 shows a diagram illustrating, in dependence of an applied magnetic field, the intensity of different contributions of optical radiation detected by an optical imaging apparatus according to an exemplary embodiment of the invention.

FIG. 8 shows a configuration of an optical radiation source and an optical radiation detector of an optical imaging apparatus according to an exemplary embodiment of the invention.

The illustration in the drawing is schematically. In different drawings, similar or identical elements are provided with the same reference signs.

In the following, referring to FIG. 1, an optical imaging apparatus 100 according to an exemplary embodiment of the invention will be described in detail.

The optical imaging apparatus 100 for examination of tissue 101 comprises an optical radiation source 102 adapted to emit a primary optical radiation beam onto the tissue 101. The optical radiation source 102 may be, for instance, a laser or a photodiode. The excitation light may be delivered to the sample 101 by direct illumination of the imaging field, with the excitation source 102 positioned either above, below or on the side of the sample 101.

Furthermore, light delivery optics 103 may optionally be provided between the optical radiation source 102 and the sample 101. Such light delivery optics 103 may comprise filters, lenses, mirrors, apertures, etc.

The light emitted by the optical radiation source 102 impinges on the sample 101 and may excite material positioned there. In reply to the absorption of this light, a secondary optical radiation beam is emitted by the sample 101 by fluorescence and/or phosphorescence.

This secondary optical light beam passes light collection optics 104 (which may comprise optical elements such as lenses, mirrors, and filters).

The emitted light may then be filtered by an emission filter 105. Any background radiation can be rejected from the collection pathway by one or a series of optical filters 105.

The light which has passed the emission filter 105 may then be detected and amplified in a detection and amplification unit 106. For detection and quantification of the re-emitted light, a multiplier tube (PMT) or a charge coupled device (CCD) can be used. After the emitted light has been detected and amplified by the detection and amplification unit 106, the analogue signal from the (PMT or CCD) detector 106 is converted to a digital signal.

Furthermore, the optical imaging apparatus 100 comprises a magnetic field generating unit 107 which is adapted to generate an inhomogeneous magnetic field along an extension of the tissue 101. The tissue 101 may comprise magnetic field sensitive dye which changes its emission properties in dependence of the present magnetic field.

The detected signal may be provided to a determining unit 108 which may be a microprocessor (CPU) or the like, wherein the determination unit 108 is adapted to determine structural information concerning the tissue 101 based on an analysis of the detected secondary optical radiation beam in combination with an analysis of the inhomogeneous magnetic field.

For this purpose, the determination unit 108 is coupled to the magnetic field generating unit 107, to the detection and amplification unit 106 and to the optical radiation source 102 and may control and coordinate these components.

A result of the determination may be provided from the determination unit 108 to a graphical user interface (GUI) 109 via which a user may monitor the results of the optical imaging.

As can be seen in FIG. 1, the magnetic field generating unit 107 comprises a plurality of conductors to which an electrical current is applicable so that a desired magnetic field distribution can be generated at the position of the tissue 101 in order to allow a modulation of the magnetic field and thus the emission properties of the sample 101.

The optical radiation detector 106 is a frequency resolving detector which may distinguish particularly two different types of radiation, namely fluorescence and phosphorescence, which may be distinguished by different frequencies. However, the optical radiation detector 106 may also be a time resolving detector capable of distinguishing between phosphorescence and fluorescence having different decay times.

As can be taken from FIG. 1, a magnetic shielding element 110 is provided which surrounds the experimental portion of the optical imaging apparatus 100 in order to shield the earth magnetic field and other disturbing magnetic fields.

As will be described in the following referring to FIG. 2, by modulating the magnetic field at the position of the tissue 101, the decay paths related to phosphorescence and fluorescence can be characteristically manipulated, so that the knowledge of the magnetic field strength and direction at a particular position of the tissue 101 may allow to investigate particularly this spatial portion.

FIG. 2 shows an energy level diagram 200 illustrating processes involved in creating an excited electronic singlet state and an excited electromagnetic triplet state by optical absorption and involved in creating subsequent emission of fluorescence and phosphorescence in the presence of an external magnetic field.

The probe attached to the tissue 101, which will be described in more detail referring to FIG. 3, has an electronic ground state 201. The system can be brought to an excited singlet state 202 upon absorption of electromagnetic radiation of the wavelength λ₀ which is the wavelength of the primary optical beam emitted by the optical radiation source 102. Optionally, the system may relax from the excited singlet state 202 to a more stable excited singlet state 203.

In the absence of an external magnetic field, a transition from the excited singlet state 203 to an excited triplet state 204 is forbidden by quantum mechanics, so that this transition path does not (significantly) populate the triplet state 204. Consequently, the system relaxes from the excited singlet state 203 to the ground state 201 under emission of a photon having the wavelength λ₁ by means of fluorescence. That is to say, the emission of the photon with the wavelength λ₁ forming the secondary optical radiation beam takes place almost without any delay with respect to the excitation. The decay time may be in the order between nanoseconds and picoseconds, for instance. Consequently, when no magnetic field is present at the position of the tissue 101, the described transmission path with an emission of photons having the wavelength λ₁ and essentially no delay is dominant.

Still referring to FIG. 2, when a magnetic field B>0 is switched on, for instance by particularly operating the magnetic field generating element 107, a transition between the excited singlet state 203 and the excited triplet state 204 becomes possible. In other words, the transition rate between the excited singlet state 203 and the excited triplet state 204 depends on the strength of the magnetic field present in the environment of a particular probe. When the magnetic field becomes larger than zero at the position of a portion of the tissue 101, a transition from the excited singlet state 203 to the excited triplet state 204 takes place, and consequently a delay transition of phosphorescence radiation having a wavelength λ₂ can be measured by the detection and amplification unit 106 as a part of the secondary optical radiation beam. Simultaneously, the intensity of the wavelength λ₁ in the secondary optical radiation beam decreases. Thus, by modulating the magnetic field at the position of a particular portion of the tissue 101, the ratio between the components λ₁ and λ₂ and the corresponding delay times can be measured by the detection unit 106 to spatially resolve a particular portion of the tissue 101.

In the following, referring to FIG. 3, tissue 101 is shown in more detail, having attached thereto a probe 302 according to an exemplary embodiment of the invention.

The probe 302 attached to the tissue 101 comprises a donor 303 adapted to absorb a primary optical radiation having the wavelength λ₀. Furthermore, an acceptor 304 is provided which is adapted to emit the secondary optical radiation with the wavelength λ₁ and/or λ₂ upon absorption of the primary optical radiation having the wavelength λ₁ by the donor 303. The donor 303 and the acceptor 304 are adapted in such a manner that at least one property of the secondary optical radiation depends on a magnetic field strength at the position of the probes 302, that is to say a position of the tissue 101.

Furthermore, a linker molecule 305 is coupled to the donor 303 and the acceptor 304 and is adapted to be attachable to the tissue 101.

For instance, tissue 101 comprises tumour cells. The linker 305 may particularly be adapted as an antibody for the tumour cells so that, in the presence of tumour cells, the linker molecules 305 are attached to the tumour cells. The donors 303 and the acceptors 304 form a system which may absorb a wavelength λ₀ and which may, in response to this, emit a secondary wavelength λ₁ or λ₂, in dependence of the value of a magnetic field 106 present in the environment of the tissue 101.

In the following, referring to FIG. 4, a flow chart 400 of an optical imaging method according to an exemplary embodiment of the invention will be described.

In a method step 410, the method starts.

In a method step 420, an inhomogeneous magnetic field is generated and applied along an extension of an object of interest.

In a method step 430, a primary optical radiation beam is emitted onto the object of interest.

In a subsequent method step 440, a secondary optical radiation beam is detected which is emitted by the object of interest upon absorbing the primary optical radiation beam.

In a method step 450, structural information concerning the object of interest is determined based on an analysis of the detected secondary optical beam in combination with an analysis of the inhomogeneous magnetic field.

In a step 460, the method ends.

It is noted that any of steps 430 and 440 may be repeated a predeterminable number of times. That is, it is possible to sequentially irradiate different portions with light and to detect the emission. It is also possible to repeat step 420 with different field configurations.

Thus, the method may be carried out in such a manner that, for different illumination events of the object and/or for different magnetic field states, the emission may be detected. It is possible to scan first the magnetic field and then the illumination, or vice versa, and it is also possible to perform these scans simultaneously. That is, there can be two coupled or interleaved loops, or a common scan.

According to an exemplary embodiment of the invention, the following measurement procedure may be performed:

An object under investigation may be connected to the measurement apparatus. Then, the spatial distribution and/or the time dependence of the magnetic field may be adjusted. Furthermore, an optical measurement sequence may be carried out. The adjustment of the magnetic field shape may then, optionally, be repeated until sufficient measurement data are obtained. Then, a mathematical analysis of the data may be performed to reconstruct an image of the object of interest or to obtain any other structural information concerning the object of interest. Subsequently, the image or the structural information may be illustrated, for instance on a display.

The described procedure may be repeated. Between different procedural steps, the measurement object may be modified, for instance by introducing an additional absorbing dye in or on the object. A process difference image may be displayed, that is to say only the concentration of the additional dye may be taken in account for such an illustration.

The performance of the optical measurement sequence may include a plurality of sub-steps: In a first sub-step, a position of irradiation, a direction of irradiation, an intensity of irradiation and/or the irradiation frequency or frequencies (spectral distribution) can be selected, and the time dependence of these and other parameters. In a second step, the light of the object under investigation may be measured, for instance at as many points as possible, simultaneously and also spectrally resolved. In a third step, the first step and/or the second step may be repeated until sufficient data is available.

The procedure includes also the inverted measurement, namely to irradiate light at one position while modifying the magnetic field form.

In the following, referring to FIG. 5, a configuration of magnetic field sources of an optical imaging apparatus according to an exemplary embodiment of the invention will be described.

The configuration shown in FIG. 5 includes a scanner having an indentation 501. In this indentation 501, a female breast 500 is inserted as an object of investigation.

A first coil 502, a second coil 503 and a third coil 504 are provided in the vicinity of the indentation 501 or reception. Furthermore, a first permanent magnet 505, a second permanent magnet 506 and a third permanent magnet 507 are located in a common housing 508 so that the array of permanent magnets 505 to 507 can be moved in common.

FIG. 5 illustrates a magnetic field source array which may be used for imaging the female breast 500. In the indentation 501 of the scanner, the female breast 500 is located. The coil system 502 to 504 is suitable to generate an essentially homogeneous magnetic field in horizontal and vertical direction of FIG. 5. A coil system which generates a magnetic field perpendicular to the paper plane of FIG. 5 is not illustrated but can be obtained, for instance, by simply rotation the coil pair for the radical field. Additionally, the movable (indicated by three arrows) array of permanent magnets 505 to 507 is provided which is capable of generating a field free point at a particular position within the female breast 500.

In the following, referring to FIG. 6, a schematic view of a magnetic field distribution generated by the magnetic field sources 505 to 507 of FIG. 5 will be illustrated.

FIG. 6 shows the magnetic field distribution 600 and the above-mentioned field free point 601. The magnetic field distribution 600 of the array of permanent magnets 505 to 507 show that the magnets 505 to 507 are arranged in such a manner that a region of small or vanishing magnetic field strength is formed, the so-called field free point 601. The field free point 601 can be moved by mechanical motion of the magnet system 505 to 507, but may also be shifted by modifying the magnetic field contributions of the coils 502 to 504 which are not shown in FIG. 6.

In the following, referring to FIG. 7, a diagram 700 will be described which illustrates, in dependence of an applied magnetic field B which is plotted along an abscissa 701 of the diagram 700, the intensity of different contributions of optical radiation detectable by an optical imaging apparatus, wherein this intensity I is plotted along an ordinate 702 of the diagram 700.

A first curve 703 illustrates a first contribution of optical radiation, and a second curve 704 illustrates a second contribution of optical radiation detectable and distinguishable by the detector system of the described optical imaging apparatus.

Thus, the diagram 700 exemplary illustrates two possible fluorescence intensity curves 703, 704 in dependence of the magnetic field 701. The fluorescence dye system's responds to an increase of the magnetic field by a modification of, for instance, fluorescence intensity. It is advantageous that the fluorescence intensity significantly changes already below 100 mT, which yields a proper resolution. A significant modification means particularly a modification by more than 5%. Using this property, together with the field free point 601, it is possible that a particular region has an increasing or decreasing fluorescence yield. By scanning or sampling the entire region of interest with the field free point 601, data can be acquired which may allow for a properly resolved reconstruction of this region.

In the following, referring to FIG. 8, a configuration of an optical radiation source 801 and an optical radiation detector 802 will be described.

FIG. 8 shows an exemplary apparatus for the optical measurement. Supply fibres 803 connect the source system 801 to the scanner 501, and detection fibres 803 connect the scanner 501 to the detector system 802. The fibres 803 cover the indentation 501 uniformly. it is possible to supply primary light with one supply fibre 803 and to simultaneously receive secondary light with all detection fibres 803.

The measurement procedure can be further improved by a fast modulation of the field free point 601 via a small distance, and to detect the intensity modulation in the received signal.

It can also be advantageous to continuously reduce the gradient strength around the field free point 601, the more the deeper the object is penetrated. From deeper layers, less photons may be obtained, and it may be advantageous to increase the dimension of the region the intensity of which is modulated.

It may also be advantageous to use a field free line or a field free plane instead of a field free point. By taking this measure, the modulated region to be sampled may be increased. In order to reconstruct the image, the field free line or plane may not only be shifted, but may also be turned or rotated. Then, the geometry may be similar like in the case of X-ray computed tomography apparatus.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. An optical imaging apparatus (100) for examination of an object of interest (101), the optical imaging apparatus (100) comprising
an optical radiation source (102) adapted to emit a primary optical radiation beam onto the object of interest (101);
an optical radiation detector (106) adapted to detect a secondary optical radiation beam emitted by the object of interest (101) upon absorbing the primary optical radiation beam;
a magnetic field generating element (107) adapted to generate an inhomogeneous magnetic field varying along an extension of the object of interest (101);
a determination unit (108) adapted to determine information concerning the object of interest (101) based on an analysis of the detected secondary optical radiation beam in combination with an analysis of the inhomogeneous magnetic field.

2. The optical imaging apparatus (100) according to claim 1,
wherein the magnetic field generating element (107) is realized as at least one conductor to which an electrical current is applicable.

3. The optical imaging apparatus (100) according to claim 1,
wherein the magnetic field generating element (107) is realized as at least one permanent magnet.

4. The optical imaging apparatus (100) according to claim 1,
wherein the optical radiation detector (106) is a spatially resolving detector.

5. The optical imaging apparatus (100) according to claim 1,
wherein the optical radiation detector (106) is a frequency resolving detector or an energy resolving detector.

6. The optical imaging apparatus (100) according to claim 1,
wherein the optical radiation detector (106) is a time resolving detector.

7. The optical imaging apparatus (100) according to claim 1,
wherein the optical radiation detector (106) is capable of distinguishing between a fluorescence component and a phosphorescence component of the secondary optical radiation beam.

8. The optical imaging apparatus (100) according to claim 1,
wherein the determination unit (108) is adapted to determine information concerning the object of interest (101) based on an analysis of a fluorescence component and/or a phosphorescence component in the secondary optical radiation beam.

9. The optical imaging apparatus (100) according to claim 8,
wherein the determination unit (108) is adapted to determine information concerning the object of interest (101) based on an analysis of a ratio between the fluorescence component and the phosphorescence component in the secondary optical radiation beam.

10. The optical imaging apparatus (100) according to claim 1,
wherein the determination unit (108) is adapted to determine structural information concerning the object of interest (101) based on an analysis of the detected secondary optical radiation beam in combination with an analysis of the inhomogeneous magnetic field.

11. The optical imaging apparatus (100) according to claim 1,
wherein the determination unit (108) is adapted to determine information concerning a selectable portion of the object of interest (101) at which portion the magnetic field strength has a predetermined value.

12. The optical imaging apparatus (100) according to claim 1,
wherein the predetermined value of the magnetic field strength is zero.

13. The optical imaging apparatus (100) according to claim 1,
wherein the magnetic field generating element (107) is adapted to modulate the magnetic field along an extension of the object of interest (101).

14. The optical imaging apparatus (100) according to claim 1,
wherein the magnetic field generating element (107) is adapted to vary the magnetic field in a controllable manner during the detection of the secondary optical radiation beam.

15. A probe (302) attachable to an object of interest (101) under examination, the probe (302) comprising
a donor (303) adapted to absorb a primary optical radiation;
an acceptor (304) adapted to emit a secondary optical radiation upon absorption of the primary optical radiation by the donor (303);
wherein the donor (303) and the acceptor (304) are adapted in such a manner that at least one property of the secondary optical radiation depends on a magnetic field strength at the position of the probe (302).

16. The probe (302) according to claim 15,
comprising a linker molecule (305) coupled to the donor (303) and to the acceptor (304) and adapted to be attachable to the object of interest (101).

17. Use of a probe (302) according to claim 15 for examining the object of interest (101) by an optical imaging method applying an inhomogeneous magnetic field varying along an extension of the object of interest (101).

18. An optical imaging method of examining an object of interest (101), the method comprising the steps of
generating (420) an inhomogeneous magnetic field varying along an extension of the object of interest (101);
emitting (430) a primary optical radiation beam onto the object of interest (101);
detecting (440) a secondary optical radiation beam emitted by the object of interest (101) upon absorbing the primary optical radiation beam;
determining (450) information concerning the object of interest (101) based on an analysis of the detected secondary optical radiation beam in combination with an analysis of the inhomogeneous magnetic field.

19. A computer-readable medium, in which a computer program of examining an object of interest (101) is stored which, when being executed by a processor, is adapted to control or carry out the steps of
generating (420) an inhomogeneous magnetic field varying along an extension of the object of interest (101);
emitting (430) a primary optical radiation beam onto the object of interest (101);
detecting (440) a secondary optical radiation beam emitted by the object of interest (101) upon absorbing the primary optical radiation beam;
determining (450) information concerning the object of interest (101) based on an analysis of the detected secondary optical radiation beam in combination with an analysis of the inhomogeneous magnetic field.

20. A program element of examining an object of interest (101), which program element, when being executed by a processor, is adapted to control or carry out the steps of
generating (420) an inhomogeneous magnetic field varying along an extension of the object of interest (101);
emitting (430) a primary optical radiation beam onto the object of interest (101);
detecting (440) a secondary optical radiation beam emitted by the object of interest (101) upon absorbing the primary optical radiation beam;
determining (450) information concerning the object of interest (101) based on an analysis of the detected secondary optical radiation beam in combination with an analysis of the inhomogeneous magnetic field.
